(19) United States
(12) Patent Application Publication
(10) Pub. No.: US 2002/0081246 A1
(43) Pub. Date: Jun. 27, 2002

(54) Photocatalytic filter

(75) Inventors: Shougo Tsukada, Tokyo (JP); Itaru Watanabe, Chiba-ken (JP); Youji Touma, Tokyo (JP); Souji Arai, Iruma-shi (JP); Shinichi Ogawa, Tokyo (JP); Masayuki Higashida, Sayama-shi (JP); Yoshikazu Nishii, Tokyo (JP)

Correspondence Address: Edward D. Manzo, Cook, Alex, McFarron, Manzo,, Cummings & Mehler, Ltd., 200 West Adams Street, #2850, Chicago, IL, 60606, US

(73) Assignee: Hoya Corporation

(21) Appl. No.: 10/039,870

(22) Filed: Jan. 3, 2002

Related U.S. Application Data
(62) Division of application No. 09/137,723, filed on Aug. 21, 1998, now abandoned.

(30) Foreign Application Priority Data
Aug. 25, 1997 (JP) 227697/1997
Dec. 19, 1997 (JP) 350939/1997

(51) Int. Cl. B01J 19/08

(52) U.S. Cl. 422/186.3; 427/212

(57) ABSTRACT

A filter material in which protrusions are formed on the surface of a fiber base material by combining the filter base material and particles for forming protrusions having at least a part covered by a photocatalyst or a material containing a photocatalyst is disclosed. A gas treatment apparatus in which a gas treatment filter made of a filter material in which a photocatalyst having a refractive index higher than that of a filter base material is carried on the surface of the filter base material is installed in atmosphere to be treated and ultraviolet rays introduced into the light guiding member are leaked from the photocatalyst, thereby treating gas by the photocatalytic reaction.

### REFERENCE TO RELATED APPLICATION

This application claims the priority right under 35 U.S.C. 119, of Japanese Patent Application Nos. Hei 09-227697 filed on Aug. 25, 1997 and Hei 09-350939 filed on Dec. 19, 1997, the entire disclosure of which is incorporated herein by reference.

### BACKGROUND OF THE INVENTION

1. Field of the Invention

The present invention relates to a filter material having photocatalytic activity, a manufacture of the material, and a photocatalytic filter. More particularly, the invention relates to a material of a photocatalytic filter suited for use in water treatment, environment purification, or the like, a method of efficiently manufacturing the material, and a photocatalytic filter using the filter material. The invention also relates to a gas treatment apparatus and a gas treatment filter for performing gas treatment such as deodorization, removal of ethylene, and removal of NOₓ and, more particularly, to a gas treatment apparatus suitable for use in a refrigerator, air cleaner, or the like and a gas treatment filter used for the gas treatment apparatus.

2. Description of the Related Arts

Photocatalytic techniques use mainly strong oxidation made by a photocatalyst represented by titanium oxide under light irradiation and are applied for a gas treatment apparatus (deodorizing apparatus, air cleaner, gas removing apparatus, exhaust gas purifying apparatus, or the like) for purifying atmosphere, exhaust gas, and the like in a room, car, chamber, or the like.

A gas treatment filter used for the conventional gas treatment apparatus in which a thin film or the like of a photocatalyst is held on the surface of a filter material having a plane shape, honeycomb shape, or the like is used and the filter material is irradiated with light from a light source from the outside.

Since a photocatalytic reaction is a reaction taking place on the surface of a photocatalyst, it is desirable that light efficiently reaches the surface of the photocatalyst. With respect to this point, the surface of the plane material is easily irradiated with light. It is, however, difficult to irradiate the whole surface of a material having a complicated shape such as a honeycomb shape with light, so that an effective photocatalytic reaction is not easily obtained.

On the other hand, the wider the surface area (per unit volume) of the gas treatment filter with which gas comes into contact is, the better. With respect to this point, the shape such as the honeycomb shape is advantageous. The plane shape does not have a sufficient surface area, so that a filtering capability is low.

In the conventional gas treatment filter and the gas treatment apparatus using the filter as described above, the filter material having a wide surface area per unit volume cannot be effectively irradiated with light and a small gas treatment filter which effectively uses the photocatalytic reaction and has high gas treatment capability cannot be obtained.

In case of purifying gas or liquid through a filter, the following three types of filters are generally used; (1) a filter in which a space for forming the filter is filled with short fibers (hereinbelow, called a short fiber filter); (2) a filter in which cloth obtained by weaving long fibers is used as a filter material (hereinbelow, called a long fiber filter); and (3) a filter made of a porous material obtained by forming and sintering granular materials or the filter in which a space for forming the filter is filled with granular materials.

In the short fiber filter, however, holes (mesh) of the filter are adjusted by mainly changing the filling density of the fibers. The density varies according to a location and it is difficult to accurately control the mesh. When a fluid is passed, the shape of the mesh is easily changed, so that there is a problem that a high-performance filter is not easily obtained.

In the long fiber filter, a complicated process for weaving long fibers into cloth is necessary, so that high costs cannot be avoided, the diameter of a fiber which can be woven is limited, and a mesh which can be realized is limited. There is consequently a problem that a high-performance filter cannot be easily obtained.

On the other hand, in the filter of the type (3), there is a case that a porous member made by granular materials according to a sintering method or the like is used as a filter. In this case, however, a large quantity of granular materials is necessary, so that a large space is required and costs are high for the formation. Thus, there is a problem that high manufacturing costs cannot be avoided.

As described above, all of the conventional filters have drawbacks and the actual situation is that it is difficult to provide a high-performance filter at low cost.

The group of the inventors had studied intensively in order to provide a high-performance filter at low cost, developed a filter material of a new type in which protrusions are formed on the surface of the filter material, and found out that a high-performance filter can be provided at low cost by using the filter material.

Meanwhile, it is known that a metal compound of a certain kind has the photocatalytic action. According to the photocatalytic action, by absorbing light energy, ionization oxide molecules such as super oxide anion (.O₂) or hydroxy radical (.OH) are generated and an organic substance is oxidation destructed as a result. In recent years, by using the photocatalytic action for a filter, an attempt to apply the action to various water treatments, air treatments, environment purification, and the like is positively made.

As metal compounds (hereinbelow, sometimes called a photocatalyst) having the photocatalytic action, for example, titanium dioxide, barium titanate (BaTi₄O₉), strontium titanate (SrTiO₃), sodium titanate (Na₂Ti₆O₁₃), zirconium dioxide, cadmium sulfide, α-Fe₂O₃, and the like are known. Among them, titanium dioxide is typical.

As described above, the group of the inventors provide the filter material in which protrusions are formed on the surface of the filter base material in order to provide a high-performance filter at low costs. In this case, in order to cheaply provide a high-performance filter having the photocatalysis, the group of the inventors provide a filter material in which protrusions are formed on the surface of the filter base material and the filter base material further carries the photocatalyst.

### SUMMARY OF THE INVENTION

In view of the foregoing circumstances, it is an object of the invention to provide a filter material which can cheaply provide a high-performance filter having photocatalysis suitably used for water treatment, environment purification, and the like, its manufacture, and a photocatalytic filter using the filter material.

It is another object of the invention to provide a small gas treatment apparatus and a small gas treatment filter each of which can efficiently develop a photocatalytic reaction and has a high processing capability.

The inventors have studied wholeheartedly in order to achieve the object and found out that a filter material in which a protrusion layer having photocatalysis is formed can be easily obtained by covering the filter base material and particles for forming protrusions with a photocatalyst or a material containing the photocatalyst and simultaneously combining them and that a high-performance filter having photocatalysis can be cheaply obtained by using the filter material. Thus, the present invention has been completed on the basis of the knowledge.

According to the invention, there are provided a filter material and a photocatalytic filter made of the filter material in which protrusions are formed on the surface, at least a part of a filter base material and particles for forming protrusions is covered by a photocatalyst or a material containing a photocatalyst, and the filter base material and the gains for forming protrusions are combined by the photocatalyst or the material containing the photocatalyst.

According to the invention, the filter material can be manufactured by simultaneously performing a step which covers a filter base material and particles for forming protrusions with a photocatalyst or a photocatalyst precursor and includes an operation for transforming the photocatalyst precursor to the photocatalyst when the photocatalyst precursor is used, and a step of combining the particles for forming protrusions with the filter base material.

A gas treatment apparatus of the invention treats gas by the photocatalytic reaction carried out by installing a gas treatment filter in which a photocatalyst having a refractive index higher than that of a light guiding member is carried on the surface of the light guiding member in atmosphere to be treated and allowing ultraviolet rays introduced to the light guiding member leak from the photocatalyst.

The shape of the light guiding member (gas treatment filter) can be properly selected from the shapes of fiber, honeycomb, mesh, cloth, sheet, and the like according to application. A light guiding member having protrusion on the surface can be also used.

According to another gas treatment apparatus of the invention, a gas treatment unit in which properly bundled photocatalytic fibers each carrying a photocatalyst having a refractive index higher than that of a light guiding member on the surface of the fiber-shaped light guiding member having protrusions are arranged between porous members is installed in atmosphere to be treated, ultraviolet rays introduced from one end or both ends of the bundled photocatalytic fibers in the gas treatment unit are allowed to leak from the photocatalyst on the surface of each of the light guiding members, and the gas is treated by the photocatalytic reaction.

The protrusions of the photocatalytic fibers are used to form a gas treatment filter having desired intervals or spaces among the photocatalytic fibers only by bundling the photocatalytic fibers almost in the same direction. The ratio of clearances or gaps of the filter or the vacancy of the filter can be optionally adjusted only by changing the size of the protrusions for the fiber, the distribution density of the protrusions (pitch or the like) or the like. The protrusion can be have any shape of ball, rod, fiber, amorphous shape, or the like. As the materials of the protrusions, for example, glass, ceramics, glass ceramics, metal, resin, and crystal can be mentioned. The protrusions can be also formed by photocatalytic particles.

In the invention, the ultraviolet rays introduced to the light guiding member are, while being guided by the light guiding member, leaked from the surface of the light guiding member and irradiated to the photocatalyst, and the photocatalyst is excited. When gas comes into contact with the excited photocatalyst on the surface, the gas is treated by being decomposed or the like by the photocatalytic reaction. As gas to be treated, for example, malodorous components such as ammonia, trimethylamine, and the like, plant growth promoting components such as ethylene, acetaldehyde, and the like, a nitrogen oxide (NOₓ), and the like in a refrigerator, vehicle, room, or the like can be mentioned.

As materials of the light guiding member, although glass, ceramics, plastics, crystal, and the like can be mentioned, it is preferable to use glass. Glass which has the property of transmitting ultraviolet rays that excite the photocatalyst and yet does not react with the photocatalyst is desirable. Specifically, quartz glass or soda-lime glass coated with quartz glass can be used. When the manufacturing costs and workability are considered, however, low-alkali silicate glass, aluminosilicate glass, borosilicate glass, or no-alkali glass having 30 to 70% by weight of SiO₂ and the percentage content of alkali components of 0 to 10% are more preferable. A single material or a mixture or composition (for example, bonding) of two or more materials of glass, ceramics, plastics, crystal, and the like can be used for the light guiding member.

When a spacer is interposed between the porous members, the interval between the porous members can be held to be constant and it can be prevented that the bundle of the photocatalytic fibers is unbound and that the gas to be treated does not pass through the bundle of the photocatalytic fibers and escape to the sides.

According to the gas treatment filter of the invention, a number of photocatalytic fibers carrying the photocatalyst having a refractive index higher than that of light guiding members on the surface of the fiber-shaped light guiding members are arranged while being aligned in the longitudinal direction, at least one end part of the number of photocatalytic fibers is fixed by a binder, and the end face of each light guiding member is polished.

Since the one end part of the number of photocatalytic fibers are fixed by the binder such as an adhesive, the fibers is prevented from being unbound and the handling in the events of polishing the end face, assembling the fibers to a gas treatment apparatus, and the like is facilitated. Since the end face of each of the light guiding members on one end is polished, ultraviolet rays from a light source or the like can be effectively combined with the photocatalytic fibers.

As photocatalysts, for example, titanium oxide, iron oxide, zinc oxide, ruthenium oxide, cerium oxide, tungsten oxide, molybdenum oxide, cadmium oxide, and strontium oxide, and their compounds can be mentioned. Those photocatalysts can be used as a single photocatalyst and two or more photocatalysts can be also mixed or jointly used.

As the method of carrying the photocatalyst, sol-gel process, pyrosol process, wash coating, vapor deposition, sputtering, thermal decomposition, metal oxidation, or the like can be used. By using one or more methods, for example, the photocatalyst is formed on the surface of the light guiding member with the film thickness of 1 nm to 1 mm.

Substances having the actions of enhancing the catalysis active layer, bonding strength, stability, light reaction, adsorption, and the like can be added as an additive to the photocatalyst or can be used as an under coat of a photocatalytic layer. As those substances, metals such as Cr, Ag, Cu, Au, Pt, Ru, Pd, Rh, Sn, Si, In, Pb, As, Sb, and P, their oxides or compounds can be used.

### BRIEF DESCRIPTION OF THE DRAWINGS

FIG. 1 is a schematic diagram of an apparatus for forming a protrusion layer having photocatalysis on the surface of a fiber used in Example 1;

FIG. 2 is a microphotograph of a glass fiber having the protrusion layer on the surface obtained in Example 1;

FIG. 3 is a microphotograph of an example of the glass fiber which does not have a protrusion layer on the surface;

FIG. 4 is an X-ray diffraction chart of a solidified member of a coating liquid used in Example 1 obtained by performing a drying operation;

FIG. 5 is an X-ray diffraction chart of a solidified member of a coating liquid used in Example 3 obtained by performing heat treatment;

FIG. 6 is a schematic diagram of an apparatus different from that of FIG. 1 for forming a protrusion layer having the photocatalysis on the surface of a fiber used in Example 4;

FIG. 7 is a detailed diagram of a photocatalytic filter produced in Example 6;

FIG. 8 is a schematic diagram of a photocatalytic filter apparatus used in Example 6;

FIG. 9 is a graph showing the relation between elapsed time and the concentration of acetaldehyde in an acetaldehyde decomposition process in Example 6;

FIG. 10 is a schematic diagram showing an example of a gas treatment apparatus according to the invention;

FIG. 11 is a diagram; showing an example of a photocatalytic fiber;

FIG. 12 is a perspective view showing an embodiment of a gas treatment filter;

FIG. 13 is a diagram showing another example of a porous member;

FIG. 14 is a diagram showing methods of fixing porous members;

FIG. 15 is a diagram showing methods of attaching an ultraviolet light;

FIG. 16 is a diagram showing a method of reflecting ultraviolet rays of the ultraviolet light toward the photocatalytic fiber side;

FIG. 17 is a diagram showing another embodiment of the gas treatment apparatus of the invention;

FIG. 18 is a diagram showing another embodiment of the gas treatment apparatus of the invention;

FIG. 19 is a diagram showing another embodiment of the gas treatment apparatus of the invention;

FIG. 20 is a diagram showing another embodiment of the gas treatment apparatus of the invention; and

FIG. 21 is a diagram showing another embodiment of a gas treatment filter of the invention.

### DETAILED DESCRIPTION OF THE PREFERRED EMBODIMENTS

First, a filter material of the invention will be described.

A filter base material used for a filter material of the invention is not especially limited. An arbitrary one of filter base materials which are conventionally used can be selectively used. As the base materials, for example, glass, ceramics, glass ceramics, metal, metal mesh, plastics, crystal, and the like can be mentioned. In order to make the photocatalytic action effectively develop, light transmitting materials such as glass, ceramics, plastics, and crystal are preferable. The filter base material can be made of a single material or a mixture or composite (for example, bonding) of two or more kinds of materials.

It is preferable that the light-transmitting filter base material does not react with the photocatalyst itself. Further, a material which does not reduce the photocatalytic activity is more preferable.

As the base material which does not reduce the photocatalytic activity, a material which does not diffuse an impurity into the photocatalyst, does not deteriorate the photocatalytic activity, easily forms a photocatalytic thin film, has excellent chemical durability, transparency, and the like, and can form in a long fiber shape can be mentioned.

As such a base material, for example, low-alkali silicate glass, aluminosilicate glass, borosilicate glass, or no-alkali glass containing 30 to 70% by weight of SiO₂ and 0 to 10% by weight of alkali components can be mentioned.

The shape of the filter base material is not especially limited. For example, known shapes such as fiber, plate, rod, beads, cloth, particles, (including porous member) and the like can be mentioned. The fiber and plate shapes are advantageous since a filter can be cheaply obtained only by binding or stacking the filter material.

As the filter base material, especially, a glass fiber for carrying a photocatalyst is suitable.

Further, in order to effectively develop the photocatalytic action, a light guiding base material can be used. In this case, the light transmitting base material such glass, ceramics, plastics, crystal, or the like can be used as a material. Those materials can be used as a single material or a mixture or composite (for example, joined) of two or more materials. As the shape of the light guiding base material, for example, shapes such as fiber, honeycomb, mesh, cloth, layer and cotton can be mentioned. The light guiding base material can be in a single shape or a composite shape (for example, joined) of two or more shapes.

When the light guiding base material is in a fiber shape, light entering one of the ends of the fiber is propagated through the fiber while being leaked from the side face little by little. Consequently, the photocatalyst formed on the surface can be efficiently irradiated with light.

As the photocatalysts used for the filter material of the invention, conventionally known materials such as titanium dioxide, strontium titanate (SrTiO₃), barium titanate (BaTi₄O₉), sodium titanate (Na₂Ti₆O₁₃), zirconium dioxide, cadmium sulfide, α-Fe₂O₃, K₄Nb₆O₁₇, Rb₄Nb₆O₁₇, K₂Rb₂Nb₆O₁₇, and Pbₗ₋ₓK₂ₓNb₂O₆ can be mentioned. Those materials can be used as a single material or a combination of two or more materials. Among the above, titanium dioxide is suitable from the viewpoints of the photocatalysis and economical efficiency. There are rutile and anatase types for titanium dioxide. Anatase titanium dioxide is more preferable than rutile titanium dioxide from the viewpoint of the photocatalysis.

On the other hand, with respect to particles for forming protrusions used for the filter material of the invention, the shape is not especially limited. For example, spherical shape, amorphous shape, rod shape, scale shape, fiber shape, porous member, and the like can be mentioned. Materials such as ceramics, glass, glass ceramics, metal, plastics, crystals (alumina, zirconia, titania, mullite, cordierite, magnesia, barium titanate, and the like), and particles (vitreous particles, crystalline particles, and the like) can be mentioned.

Although one kind or a combination of two or more of the particles for forming the protrusions can be used, especially, glass beads are preferable. The size of the particle cannot be unconditionally determined as it is different according to the shape. However, in case of a spherical shape such as a glass bead, for example, the average particle size in a range from 0.1 to 1,000 μm is preferable and that in a range from 2 to 200 μm is especially preferable.

The distribution density of the protrusions is not especially limited and is properly selected in consideration of the degree of vacancy (mesh), loss of pressure, pressure and quantity of a fluid, strength, diameter, and thickness of the base material, the collection ratio, and the like.

In the filter material of the invention, the filter base material and the particles for forming the protrusions are covered by the photocatalyst or the material containing the photocatalyst and they are combined.

As for the manufacture of such a filter material, according to the invention, a desired filter material can be manufactured by simultaneously performing a step which covers the filter base material and the particles for forming the protrusions with the photocatalyst or the photocatalyst precursor and includes an operation for transforming the photocatalyst precursor into the photocatalyst when the photocatalyst precursor is used and a step of combining the particles for forming the protrusions to the filter base material.

In this case, specifically, the following two methods are used; (1) a method of applying and drying a coating liquid obtained by suspending the photocatalyst and particles for forming protrusions into a binder solution onto the surface of the filter base material, thereby forming a protrusion layer having the photocatalysis, and (2) a method of applying a coating liquid obtained by suspending particles for forming protrusions into a binder (photocatalyst precursor) solution which displays the photocatalysis by heat treatment onto the surface of the filter base material and performing heat treatment, thereby forming a protrusion layer having the photocatalysis.

The first (1) method will be described.

### First Method

As a binder solution in the first method, a solution obtained by solving various binders into a proper solvent is used. As binders in this case, for example, an alkoxide compound of silicon, a silicone resin, and an organic compound containing silicon, an alkoxide compound of zirconium, an organic compound containing zirconium, an alkoxide compound of aluminum, an organic compound containing aluminum, an alkoxide compound of titanium, an organic titanium compound, and the like can be mentioned.

As an alkoxide compound of silicon, tetraethyl orthosilicate, tetramethyl orthosilicate, methyltriethoxysilane, and the like and their oligomers can be described. As examples of silicone resins, methyl silicone resin, phenyl silicone resin, methylphenyl silicone resin, and the like can be mentioned. As other organic compounds containing silicon, methyl siryl tri-isocyanate and its oligomer can be mentioned. As an alkoxide compound of zirconium and other organic compounds containing zirconium, zirconium tetra-n-propoxide, zirconium tetra-n-butoxide, and oligomers of them, zirconium acetate, zirconium acethylacetonate, and oligomers of them, and the like can be mentioned. As an alkoxide compound of aluminum and other organic compounds containing aluminum, aluminium tri-sec-butoxide, its oligomer, aluminum di-isopropoxide ethyl acetoacetate chelate, its oligomer, and the like can be mentioned.

As an alkoxide compound of titanium and other organic titanium compounds, titanium tetra-n-butoxide, titanium tetra-isopropoxide, titanium tetra ethoxide, tetra (2-ethylhexyl oxy) titanium, tetrastearyl oxytitanium, dihydroxy bis (acetylacetonate) titanium, di-n-butoxy (triethanolaminato) titanium, titanium isopropoxide octylene glycolate and oligomers of them, dihydroxy bis (lactate) titanium, titanium stearate, and oligomers of them, and the like can be mentioned.

Those binders can be used as a single binder or a combination of two or more binders. A solvent used for preparing a binder solution is not especially limited as long as it can solve the binder, has volatility, and is easy when the coating film is dried. Various organic solvents, for example, alcohol, ester, ketone, and ether solvents can be used. Those solvents can be used as a single solvent or a mixture of two or more solvents. The concentration of a binder in a binder solution is not especially limited and may be properly selected in consideration of coating properties, handling properties, and the like of the coating liquid obtained.

As a photocatalyst to be added to the binder solution, those of the above mentioned kinds can be mentioned. Although the shape is not limited, especially a fine particle shape is preferable.

Preferably, the average diameter of the photocatalytic fine particle lies within a range from 5 to 1,000 nm.

Meanwhile, as the particles for forming protrusions to be suspended in the binder solution, those of the above mentioned kinds and shapes can be used.

According to the first method, a predetermined amount of the photocatalyst and particles for forming the protrusion are homogeneously suspended in the binder solution, thereby preparing a coating liquid. The coating liquid is applied to the surface of the filter base material by a known method such as dipping, flow coating, and spraying and is dried. The drying process is performed by heating the liquid at a temperature generally from 50 to 200 degrees.

In this manner, a photocatalytic protrusion layer having the thickness which is preferably from 0.01 to 40 μm and is especially preferably from 0.1 to 20 μm is formed.

The reason why the thickness of the protrusion layer is preferably 0.01 to 40 μm is as follows. When the thickness is less than 0.01 μm, the amount of the photocatalyst may be insufficient and absorption of light may be insufficient, so that there is a fear such that efficient photocatalytic action cannot be taken place. On the other hand, when the thickness exceeds 40 μm, there is the possibility that a crack easily occurs in the film and the film is peeled off from the crack.

The weight ratio of the photocatalytic fine particles, the particles for forming the protrusion, and the binder is preferably 1-85:5-85:10-90, more preferably 5-85:5-85: 10-90, and most preferably 10-70:10-70:20-80 (total 100).

The second (2) method will be now described.

### Second Method

In the second method, as a binder solution, a solution containing a binder (photocatalyst precursor) which develops the photocatalysis by heat treatment is used. As binders which develop the photocatalysis by the heat treatment in this case, for example, an alkoxide compound of titanium, an organic titanium compound and the like can be used.

As an alkoxide compound of titanium, titanium tetra-n-butoxide, titanium tetra-isopropoxide, titanium tetra ethoxide, tetra (2-ethylhexyl oxy) titanium, tetrastearyl oxytitanium, di-isopropoxy bis (acetylacetonate) titanium, di-n-butoxy (triethanolaminato) titanium, titanium isopropoxy octylene glycolate, and oligomers of them can be mentioned. As other organic titanium compounds, dihydroxy bis (lactate) titanium, titanium stearate, and oligomers of them can be mentioned. In those titanium compounds, crystals of anatase-type titanium dioxide are deposited by heat treatment at about 400 to 700 degrees and the photocatalytic action is developed. When the temperature of the heat treatment is too high, since rutile-type titanium dioxide is formed, it is not preferable. Thus, the above range is appropriate.

Those titanium compounds can be used as a single compound or a combination of two or more kinds. A proper amount of another binder, for example, a binder except for the titanium compound described in the first method can be also used according to necessity.

As a solvent used for preparing a binder solution, a solvent is not especially limited as long as it can solve the binder and has volatility. Various organic solvents, for example, alcohol, ester, ketone, and ether solvents can be used. Those solvents can be used as a single solvent or a mixture of two or more solvents can be also used. The concentration of a binder in a binder solution is not especially limited and may be properly selected in consideration of coating properties, handling properties, and the like of the coating liquid obtained.

As the particles for forming protrusions to be suspended in the binder solution, in a manner similar to the first method, those of the above mentioned kinds and shapes can be used.

According to the second method, a predetermined amount of the particles for forming the protrusion are homogeneously dispersed in the binder solution which develops the photocatalysis by the heat treatment, thereby preparing a coating liquid. The coating liquid is applied to the surface of the filter base material by a known method such as dipping, flow coating, and spraying. Subsequently, the drying process is performed according to necessity at a temperature from about 50 to 200 degrees and, after that, heat treatment at about 400 to 700 degrees is carried out, thereby forming a photocatalytic protrusion layer having the thickness which is preferably from 0.01 to 40 μm and is especially preferably from 0.1 to 20 μm.

The abundance ratio of the particles for forming the protrusion in the photocatalytic protrusion layer and the binder (photocatalyst) is preferably 1-90:10-99 and is especially preferably 5-80:20-95 by weight ratio (total 100).

In the second method, in the preparation of the coating liquid, in order to promote the hydrolytic reaction of the binder which develops the photocatalysis by the heat treatment such as an alkoxide compound of titanium, the coating liquid is adjusted by an acid such as normal hydrochloric acid so that pH is on the acidic side.

In the first and second methods, for purposes of improving the photocatalysis, enhancing the bonding strength of the protrusion layer to the base material, and the like, powders of a metal such as Ag, Cu, Au, Pt, Ru, Pd, Rh, Sn, Si, In, Pb, As, and Sb or a compound of an oxide of the metal can be added to the coating liquid when desired. It is also possible that a coat layer containing a compound of the metal or an oxide of the metal is preliminarily formed on the surface of the filter base material, the coating liquid is applied on the coat layer, and the protrusion layer is formed by performing the dry or heat treatment.

In this manner, the filter material in which the protrusion layer having the photocatalysis is formed on the surface of the material can be efficiently obtained.

Preferable parameters of the protrusion layer are similar to those of the first method.

According to the invention, the photocatalytic filter made of the filter material obtained by the foregoing method is provided.

For construction of the filter by using the filter material, a known filter mode according to the shape of the filter material or the like can be used.

For example, when the filter is constructed by using the fibers each having the protrusion layer on its surface as a filter material, only by bundling and fixing a plurality of fibers in the almost same direction, a filter having predetermined gaps (mesh) can be formed. In this case, the fineness of the mesh can be arbitrarily changed according to the size of the protrusion, intervals, distribution density, and the like.

For example, when the filter is constructed by using boards each having the protrusion layer on its surface as a filter material, only by stacking and fixing the plurality of boards, a filter having predetermined gaps (mesh) can be formed. In this case, the fineness of the mesh can be arbitrarily changed according to the size of the protrusion, intervals, distribution density, and the like.

Further, in the invention, the filter in which a light guiding member for guiding light having a wavelength necessary to make the photocatalyst in an active state is used as a filter material, the light guided by the light guiding member comes out from the surface of the light guiding member and reaches the photocatalyst can be realized. In this case, as mentioned above, any shape such as fiber, honeycomb, mesh, cloth, layer, cotton, or the like can be used as the shape of the light guiding member. The shape can be a single shape or a composite shape of two or more kinds.

When each of the light guiding members is in a fiber shape, they are stacked by being bundled or the like as a filter material. Only making light enter from one of the ends, the light can be guided to the photocatalyst formed on the surface of the filter material.

When the photocatalyst and the light guiding material are selected, the refractive indices of them are to be considered. Different from an optical fiber in which light is closed in a core, it is necessary to leak the light to the photocatalyst layer side as a covering material, so that it is advantageous to select a photocatalyst having a refractive index higher than that of the light guiding material.

The filter material of the invention has the following effects in comparison with a filter material in which a fiber on which protrusions are preliminarily formed is covered with a photocatalyst. (i) Since the protrusions are not formed on the fiber itself in the fiber material of the invention, light is not scattered by the protrusions unlike the case where protrusion are formed on the surface of the fiber by making the surface rough. Consequently, the whole area including the ends of the filter material can be used. (ii) When it is assumed that protrusions of the same size are formed on both of the materials, more photocatalyst can be attached to the light guiding member on which the protrusions are not preliminarily formed because the photocatalyst can be provided between the protrusions and the light guiding member. When the amount of the photocatalyst increases, the photocatalytic capability is accordingly increases. (iii) The filter material of the invention can be manufactured easier than the filter material to which protrusions are preliminarily formed.

In the filter apparatus in which the photocatalytic filter of the invention is attached, in order to make the photocatalytic reaction take place in the protrusion layer having the photocatalysis formed on the surface of the base material, the light source is installed so that the protrusion layer is irradiated with light of the wavelength necessary to make the photocatalyst active. When titanium dioxide is used as a photocatalyst, ultraviolet rays having the wavelength of 200 to 500 nm which can excite titanium dioxide are preferable, so that a mercury lamp or an ultraviolet lamp which continuously generates ultraviolet rays can be used.

In the photocatalytic filter of the invention, the photocatalytic reaction takes place on its surface, strong oxidation and reduction forces are generated, and substances captured by the filter are decomposed and removed. As substances which can be captured in gas and can be decomposed and removed, fumes, dusts, atmosphere dust, smoke of a cigarette, virus, bacteria, malodorous substances (acetaldehyde, methyl mercaptan, and the like), and the like can be mentioned. As substances contained in the solution, for example, polluted sludge, organic substances, trihalomethane, and the like can be mentioned.

The filter apparatus in which the photocatalytic filter of the invention is attached can be suitably used as a diesel particulate filter (DPF) for removing graphite, particulate solids of unburned hydro carbon and lubricant included in exhaust gas from a diesel engine, a gas treatment filter (for example, air filter for cleaning a room, air cleaner), a liquid treatment filter (for example, a filter for purifying water or sea water), or the like.

Although the invention will be described by examples further in detail, the invention is not limited by the embodiments.

### Example 1 (first method)

1.50 kg of methyl silicone resin was solved in a mixture solution of 8.50 kg of acetate isobutyl and 17.00 kg of isopropyl alcohol, and after that, 1.5 kg of anatase-type titanium ultrafine particles having the average particle size of 20 nm was added and dispersed by using a bead mill. 1.5 kg of glass beads having the average particle size of 15 μm was suspended in the dispersion liquid, thereby preparing 30 kg of a coating liquid.

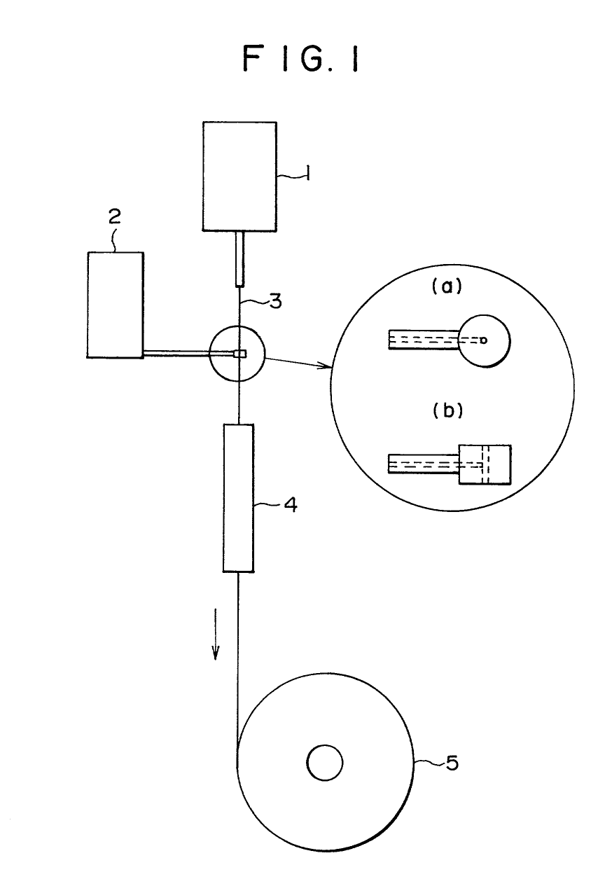

By using an apparatus shown in FIG. 1, while pulling a glass fiber as described hereinbelow, the coating liquid was applied to the surface and was dried and a protrusion layer having photocatalysis was formed.

FIG. 1 is a schematic diagram of an apparatus for forming a protrusion layer having photocatalysis on the surface of a fiber. A coating liquid supplied from a coating liquid supplying apparatus 2 is applied to the surface of a glass fiber 3 spun by a spinning apparatus 1 and is dried in a heating furnace 4 at 150 degrees and a protrusion layer having photocatalysis is formed. The glass fiber 3 is taken up by a take-up roll 5. (a) is a drawing when the coating liquid coating part is seen from above and (b) is a drawing when it is seen from a side.

In the filter material obtained in this manner, the diameter of the glass fiber was 125 μm (before the formation of the protrusion layer, similarly described hereinbelow) and the average thickness of the protrusion layer was 16 μm. When the surface of the fiber was observed by a microscope, it was found that a number of protrusions were formed. Although the filter material was strongly wiped with “Kimwipe, wiper S200” (trade name, made by Jujo Kimbary K. K.) which was wet by isopropyl alcohol, the protrusions were not come off.

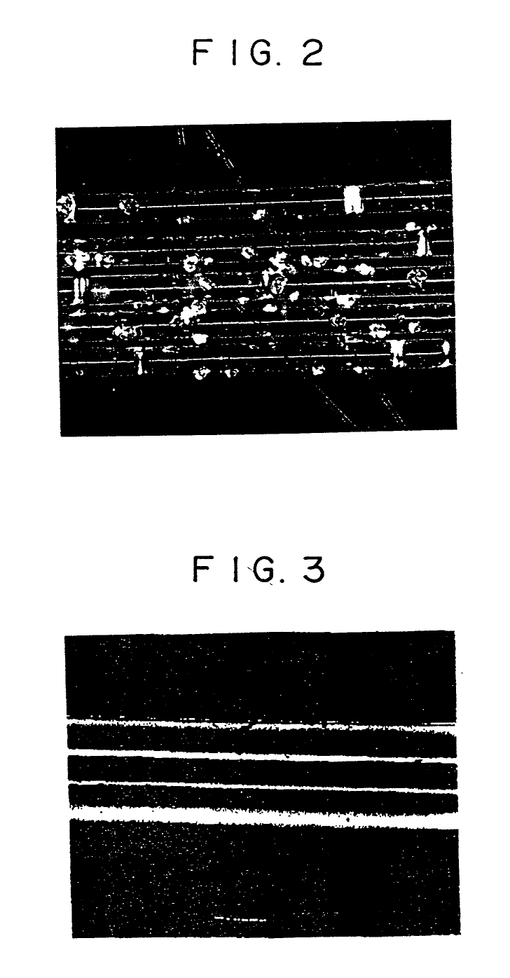

FIG. 2 is a microphotograph of (two) glass fibers each having the protrusion layer on the surface. For reference, a microphotograph of (two) glass fibers having no protrusion layer is shown in FIG. 3.

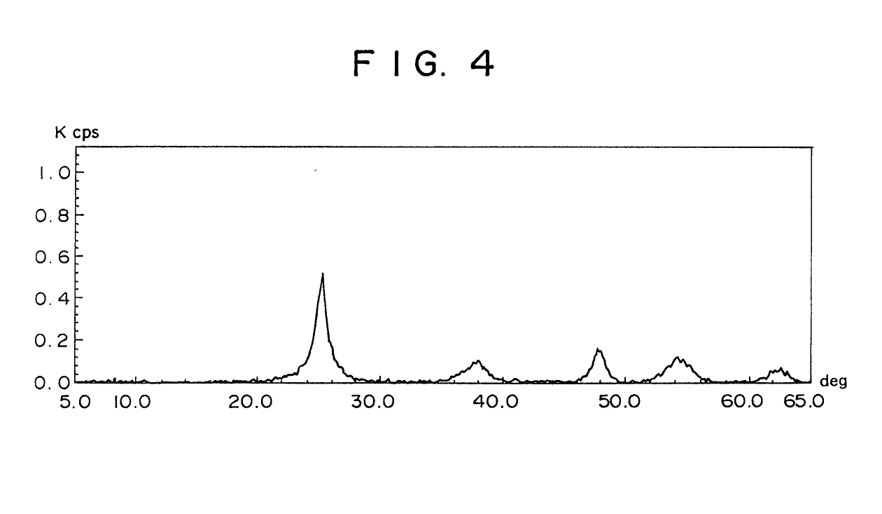

X-ray diffraction was performed to a solidified member of the coating liquid which was heat treated at 150 degrees. The chart is shown in FIG. 4.

### Example 2 (first method)

1.0 kg of glass beads having the average particle size of 10 μm was suspended into 29.0 kg of a photocatalytic titanium oxide coating liquid (made by Ishihara Techno Co., trade name: ST-KO3, anatase titanium, 5% by weight of particles diffused liquid), thereby preparing a coating liquid.

The coating liquid was charged into a cylindrical container having the diameter of 100 mm and the length of 700 mm, while applying supersonic waves, and applied to a bundle of glass fibers (about 10,000 glass fibers each having the diameter of 30 μm) by a dip coat method, and heated at 150 degrees, thereby forming the protrusion layer having photocatalysis.

In the filter material obtained in this manner, the average thickness of the protrusion layer was 11 μm. When the surface was observed by a microscope, it was found that a number of protrusions were formed. Although the filter material was strongly wiped with Kimwipe wet by isopropyl alcohol, the protrusions were not come off.

### Example 3 (second method)

While agitating a mixture solution of 3.76 kg of acetylacetone (stabilizer) and 8.84 kg of isopropyl alcohol, 6.39 kg of titanium tetra-n-butoxide was added and the solution was mixed overnight. A mixture solution of 677 g of hydrochloric acid water having the concentration of 0.15 mol/lit. and 8.84 kg of isopropyl alcohol was gradually added to the solution and the resultant solution was agitated for three hours. After that, 1.5 kg of glass beads having the average particle size of 10 μm was suspended, thereby preparing 30 kg of a coating liquid.

By using the same apparatus (the apparatus shown in FIG. 1) as that of Example 1, the coating liquid was coated on the surface of the glass fiber while pulling the glass fiber in a manner similar to Example 1 and dried at 150 degrees in the heating furnace 4, thereby forming a coating layer made by the glass beads and the precursor of titanium on the surface of the fiber. Heat treatment was performed at 600 degrees for one hour (in atmosphere) and a protrusion layer having photocatalysis was formed.

In the filter material obtained in this manner, the diameter of the glass fiber was 70 μm and the average thickness of the protrusion layer was 11 μm. When the surface was observed by a microscope, it was found that a number of protrusions were formed. Although the filter material was strongly wiped with Kimwipe wet by isopropyl alcohol, the protrusions were not come off.

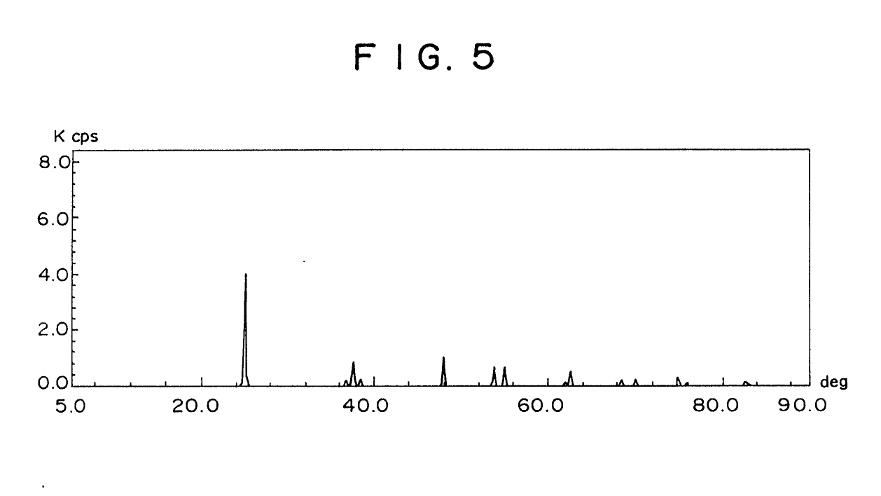

X-ray diffraction was performed to a solidified member of the coating liquid which was subjected to the heat treatment at 600 degrees (in atmosphere) for one hour. FIG. 5 shows the chart. Consequently, it was found that the anatase titanium was crystallized.

### Example 4 (second method)

1.27 kg of tetraethyl orthosilicate and 3.66 kg of isopropyl alcohol were mixed, 110 g of hydrochloric acid water having the concentration of 0.15 mol/lit. was gradually added, and the resultant solution was agitated for one hour. 4.04 kg of titanium tetra isopropoxide was added to the solution, the resultant solution was further mixed for one hour, 3.70 kg of acetacetateethyl was added, and the resultant solution was agitated overnight. A mixture solution of 731 g of hydrochloric acid water having the concentration of 0.15 mol/lit. and 15.00 kg of isopropyl alcohol was gradually added to the solution and the resultant solution was agitated for three hours. After that, 1.5 kg of glass beads having the average particle size of 5 μm was suspended, thereby preparing 30 kg of a coating liquid.

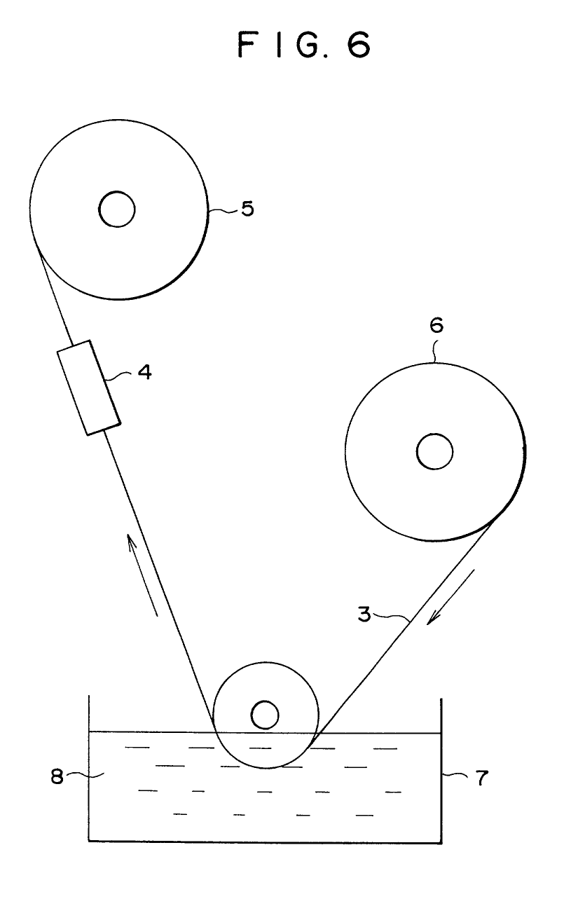

By using an apparatus of FIG. 6, as described below, the coating liquid was coated on the surface of the glass fiber, dried, and subjected to heat treatment, thereby forming a protrusion layer having photocatalysis.

FIG. 6 is a schematic diagram of the apparatus different from that of FIG. 1 for forming the protrusion layer having photocatalysis on the surface of a fiber. The glass fiber 3 fed from a delivery roll 6 passed through a coating liquid 8 charged in a coating liquid vessel 7 so that the coating liquid was coated on the surface. The glass fiber 3 was dried in the heating furnace 4 at 150 degrees, subjected to heat treatment at 600 degrees for one hour (in atmosphere) and was taken up by the take-up roll 5.

In the filter material obtained in this manner, the diameter of the glass fiber was 40 μm and the average thickness of the protrusion layer was 6 μm. When the surface was observed by a microscope, it was found that a number of protrusions were formed. Although the filter material was strongly wiped with Kimwipe wet by isopropyl alcohol, the protrusions were not come off.

When x-ray diffraction was performed to a solidified member of the coating liquid which was subjected to the heat treatment at 600 degrees (in atmosphere) for one hour, it was found that the anatase titanium was crystallized.

### Example 5 (second method)

30 kg of a coating liquid was prepared by suspending 1.5 kg of glass beads having the average particle size of 30 μm in 28.5 kg of a titanium thin film coating liquid (made by Nippon Soda Co., Ltd. trade name: NTi-500, of a type in which anatase-type titanium is deposited by heat treatment).

In a manner similar to Example 3, while pulling the glass fiber, the coating liquid was coated on the surface, dried at 150 degrees, and subjected to heat treatment at 500 degrees for one hour (in atmosphere), thereby forming a protrusion layer having photocatalysis.

In the filter material obtained in this manner, the diameter of the glass fiber was 50 μm and the average thickness of the protrusion layer was 31 μm. When the surface was observed by a microscope, it was found that a number of protrusions were formed. Although the filter material was strongly wiped with Kimwipe wet by isopropyl alcohol, the protrusions were not come off.

When x-ray diffraction was performed to a solidified member of the coating liquid which was subjected to heat treatment at 500 degrees for one hour in atmosphere, it was found that anatase-type titanium was crystallized.

### Example 6 (photocatalytic filter)

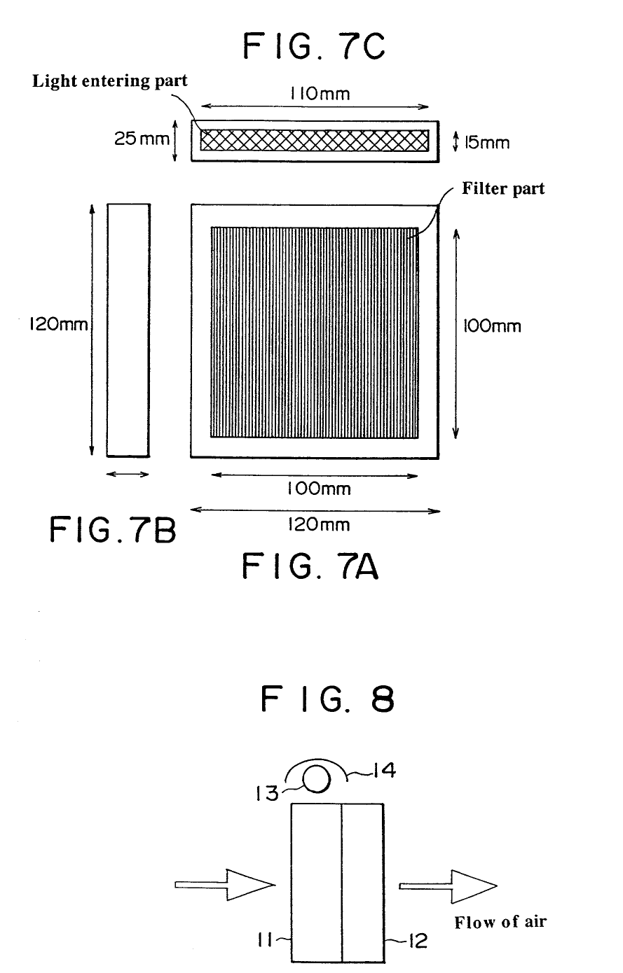

A photocatalytic filter shown in FIG. 7 was produced by using about 90,000 glass fibers obtained in Example 3 and each of which has the protrusion layer having the photocatalysis on its surface and a photocatalytic filter apparatus as shown in FIG. 8 was constructed. FIG. 7 is a detailed diagram of the photocatalytic filter, in which (a) is a front view, (b) is a side view, and (c) is a top view. FIG. 8 is a schematic diagram of the photocatalytic filter apparatus, showing that the apparatus comprises a photocatalytic filter 11, a fan 12, and an ultraviolet light source lamp 13 having a reflecting mirror 14.

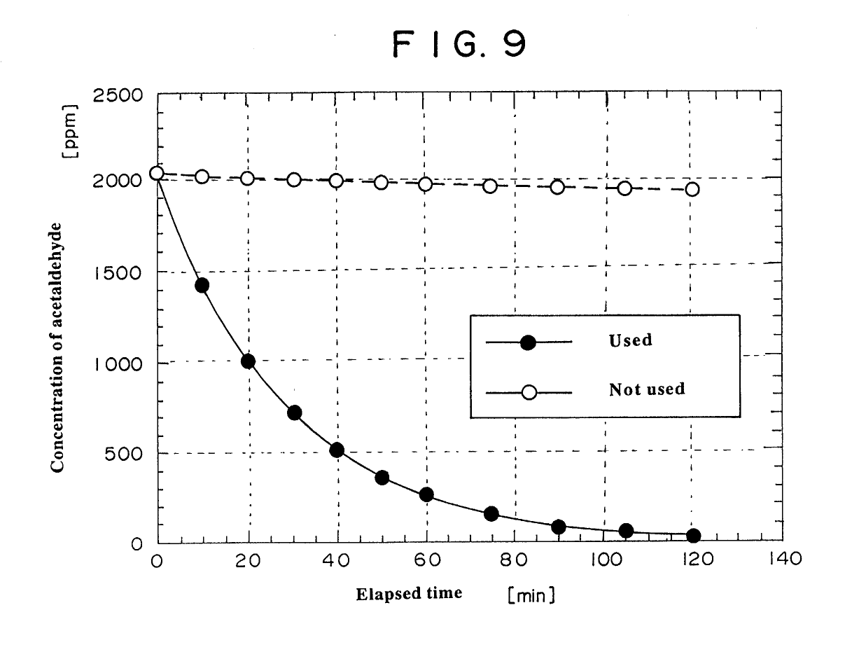

The photocatalytic filter apparatus was received in a container having a content volume of 20 lit., a process for decomposing acetaldehyde (gas) was performed, and the catalytic capability was evaluated. The intensity of ultraviolet rays at the end face of the fiber was 1.0 mW/cm² and the initial concentration of acetaldehyde was set to about 2000 ppm. The relation between elapsed time and the concentration of acetaldehyde was shown in the graph of FIG. 9. In FIG. 9, painted circles show a case where the photocatalytic filter was used and blank circles show a case where the apparatus was not used.

From FIG. 9, it is understood that the photocatalytic filer used has excellent photocatalytic action.

An embodiment of a gas treatment apparatus and a gas treatment filter according to the invention will be described hereinbelow.

The filter material obtained by combining the filter base material and the particles for forming protrusions has been described in the foregoing embodiment. In the gas treatment apparatus and filter of the invention described hereinbelow, however, attention has to be paid to the fact that a filter material obtained by coating a fiber preliminarily having protrusion with a photocatalyst can be also used.

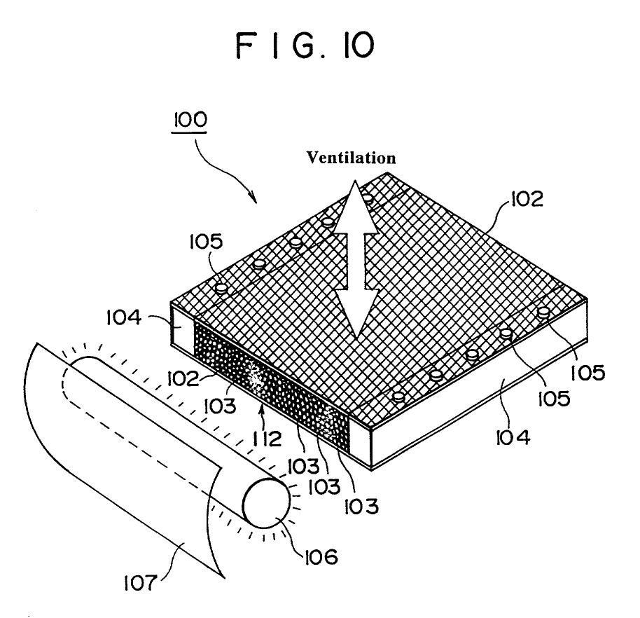

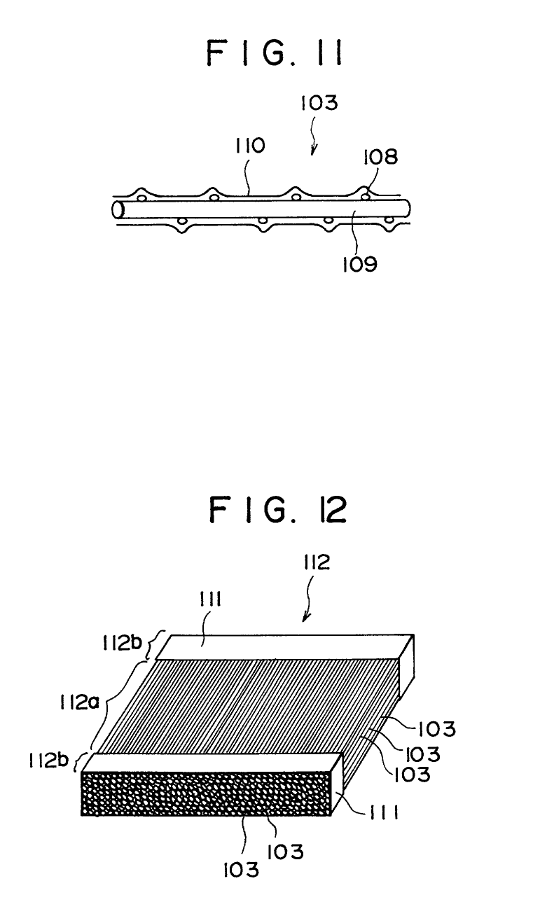

FIG. 10 shows an embodiment of the gas treatment apparatus of the invention.

In FIG. 10, reference numeral 100 denotes a gas treatment unit and main components of the gas treatment unit 100 are metal filters 102 as porous member, a number of photocatalytic fibers 103 in a bundled state sandwiched by the metal filters 102, 102, and spacers 104, 104 which define the interval between the metal filters 102, 102 and prevent a gas to be treated from being escaped to the sides without passing through the bundle of the photocatalytic fibers 103. Each of the photocatalytic fibers 103 is arranged along the longitudinal direction of the prismatic spacer 104.

The metal filter 102 was obtained by vacuum sintering and rolling stainless meshes, for example, a 20-mesh, a 30-mesh, and a 60-mesh and has the gas permeability and the strength to hold the photocatalytic fibers 103 in a pressed state. The metal filters 102, 102 are fixed to the spacers 104, 104 by screws 105.

On one end side of the bundled photocatalytic fibers 103, as shown in the diagram, a straight tube shaped ultraviolet light 106 for introducing ultraviolet rays into light guiding members of the photocatalytic fibers 103 is installed. Light from the ultraviolet light 106 is near ultraviolet radiation of about 320 to 450 nm which is not harmful to people, vegetables, and the like. The end face of the photocatalytic fiber 103 facing the ultraviolet light 106 is polished so that the ultraviolet rays are efficiently introduced. On the side opposite to the photocatalytic fibers 103 of the ultraviolet light 106, a reflecting mirror 107 having the reflecting face in a circular shape in cross section is provided so that light from the light 106 is efficiently irradiated to the end face of the photocatalytic fiber 103.

As shown in FIG. 11, the photocatalytic fiber 103 carries a photocatalyst 110 having a refractive index higher than that of the light guiding member 109 on the surface of the fiber-shaped light guiding member 109 having protrusions 108. The light guiding member 109 in the fiber shape is obtained by, for example, fusing glass in a platinum crucible and forming the fused glass in a fiber shape by a pushing method. As for the formation of the protrusions 108, there is a method of forming the protrusions by fixing granular or powdery materials to the surface of a fiber. For example, the protrusions 108 are formed by immersing the fiber-shaped light guiding member 109 in a binder liquid in which granular or powdery materials of SiO2 or the like which will become the protrusions 108 are solved and by taking out the light guiding member 109 (protrusions can be also formed on the surface of a fiber by using a die, or granular or powdery materials which will become the protrusions 108 are mixed in the material of the light guiding member, and the mixture is formed in a fiber shape, thereby forming a fiber-shaped light guiding member having protrusions). Subsequently, the photocatalyst 110, TiO2 in this case, is carried on the surface of the fiber-shaped light guiding member 109 having the protrusions 108 by using a sol-gel method or the like, thereby obtaining the photocatalytic fiber 103.

As a material of the light guiding member 109, glass which has a high transmittance for ultraviolet rays which excite the photocatalyst and does not react with the photocatalyst is desirable. A specifically preferable material contains 30 to 70 wt % of SiO₂, 1 to 35 wt % of Al₂O₃, 0 to 30 wt % of B₂O₃, 0 to 20 wt % of MgO, 0 to 40 wt % of CaO, 0 to 20 wt % of SrO, 0 to 40 wt % of BaO, 0 to 20 wt % of ZnO, 0 to 10 wt % of Li₂O, 0 to 10 wt % of Na₂O, 0 to 10 wt % of K₂O, 0 to 10 wt % of Cs₂O, 0 to 10 wt % of Li2O+Na₂O+K₂O+Cs₂O, and 0.1 to 65 wt % of MgO+CaO +SrO+BaO+ZnO+Li₂O+Na₂O+K₂O+Cs₂O.

As a glass material of the fiber-shaped light guiding member, preferable is a material containing 30 to 65 wt % of SiO₂, 1 to 20 wt % of Al₂O₃, 0 to 20 wt % of B₂O₃, 0 to 20 wt % of MgO, 0 to 40 wt % of CaO, 0 to 20 wt % of SrO, 0 to 40 wt % of BaO, 0 to 20 wt % of ZnO, 1 to 60 wt % of MgO+CaO+SrO+BaO+ZnO, 0 to 10 wt % of Li₂O, 0 to 5 wt % of Na₂O, 0 to 5 wt % of K₂O, 0 to 5 wt % of Cs₂O, 0 to 5 wt % of Li₂O+Na₂O+K₂O+Cs₂O, and 1 to 60 wt % of MgO+CaO+SrO+BaO+ZnO+Li₂O+Na₂O+K₂O +Cs₂O.

As a glass material of the fiber-shaped light guiding member, especially preferable is a material containing 49 wt % of SiO₂, 11 wt % of Al₂O₃, 15 wt % of B₂O₃, 1 wt % of CaO, and 24 wt % of BaO, a material containing 58 wt % of SiO₂, 15 wt % of Al₂O₃, 12 wt % of B₂O₃, 2 wt % of MgO, 4 wt % of CaO, 4 wt % of SrO, and 5 wt % of BaO, or a material containing 53 wt % of SiO₂, 14 wt % of Al₂O₃, 9 wt % of B₂O₃, 2 wt % of MgO, 20 wt % of CaO, 1 wt % of BaO, and 1 wt % of K₂O.

Since the protrusions 108 are formed on the photocatalytic fiber 103, only by bundling the photocatalytic fibers 103 in almost the same direction, a filter member having desired gaps or clearances among the photocatalytic fibers 103 can be formed. The ratio of the gaps or clearances among the fibers 103 or the degree of vacancy can be optionally adjusted only by changing the size of the protrusion 108 for the diameter of the fiber-shaped light guiding member 109, the distribution density (pitch or the like) of the protrusions 108. Although the diameter of the fiber-shaped light guiding member 109 can be properly selected, the range from 1 to 200 μm is preferable. The pitch of the protrusions 108 is preferably equal to 2 to 20 times of the diameter of the light guiding member 109, more preferably 3 to 10 times. The size (diameter) of the protrusion 8 is preferably equal to about 0.3 to 100 μm.

The bundle of the photocatalytic fibers 103 is held in a space defined by the metal filters 102, 102 and the spacers 104, 104 so as not to be unbound in the construction shown in FIG. 1. In order to increase the holding and handling performance, in the embodiment, a gas treatment filter 112 having the structure in which both ends of the bundled photocatalytic fibers 103 are integrally fixed by a binder 111 is employed. As the binder 111, adhesive, resin, glass, or the like can be used.

As mentioned above, since the number of photocatalytic fibers 103 are fixed at their ends by the binder 111 such as an adhesive, the fibers 103 are prevented from being unbound. Even if the fibers are bent, they can be certainly held. Further, the handling is facilitated when the ends of the photocatalytic fibers 103 are polished or the photocatalytic fibers 103 are assembled in the gas treatment apparatus. In the gas treatment filter 112, the part of the photocatalytic fibers 103 between both ends fixed by the binder 111 is a filter part 112a and the parts of the photocatalytic fibers 103 fixed by the binder 111 are light guiding parts 112b. Consequently, the photocatalyst is not held in the photocatalytic fibers 103 of the light guiding parts 112b and it is desirable that the binder 111 serves as a cladding having a refractive index lower than that of the light guiding member 109. (The gas treatment filter is not limited by a rectangular shape in cross section as mentioned above. Any shape such as a triangle, hexagon, circle, or annular shape in cross section can be used.)

The gas treatment apparatus of the embodiment is installed in atmosphere to be subjected to gas treatment, for example, in an air-cooling passage or an introduction part of a refrigerator. The chill in the refrigerator flows through the gaps among the number of photocatalytic fibers 103 bundled between the metal filters 102, 102. On the other hand, the ultraviolet rays from the ultraviolet light 106 are irradiated onto the end faces of the photocatalytic fibers 103 and are leaked from the photocatalyst 110 having a high refractive index covering the light guiding member 109 while propagating through the photocatalytic fibers 103. In this case, malodorous components such as ammonia and trimethylamine in the chill come into contact with the photocatalyst 110 and are decomposed and removed by the photocatalytic reaction. Plant growth promoting components such as ethylene, acetaldehyde, and the like are also decomposed and removed. When a main gas treatment apparatus is used mainly as an ethylene removing filter to realize long-term preservation of vegetables, fruits, and the like, it is effective to provide the apparatus in a vegetable chamber in the refrigerator. When the gas treatment apparatus is used for an air cleaner, not only deodorization but also an NOₓ process can be performed. A measure to save electricity can be also taken by providing an odor sensor and performing gas treatment when the odor sensor senses odor.

The gas treatment filter 112 having the structure in which the number of photocatalytic fibers 103 having the protrusions 108 are bundled is used in the gas treatment apparatus and the ultraviolet rays are effectively leaked from the surface of the photocatalytic fibers 103 while guiding the ultraviolet rays through the photocatalytic fibers 103. Consequently, although the gas treatment unit 101 is of a thin type, the surface area contacting gas is large, so that high-performance gas treatment can be performed.

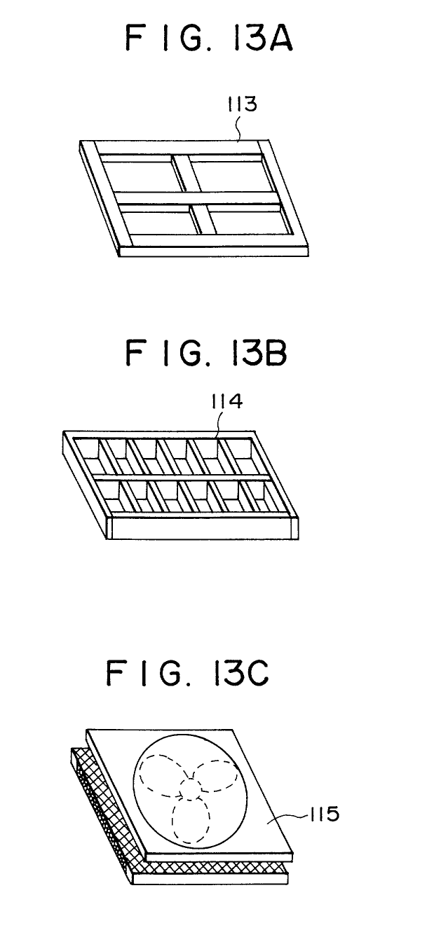

Although the metal filter 102 obtained by vacuum sintering a plurality of meshes is used as a porous member in the embodiment, instead, a porous member in which a fine metal net or a plastic net attached to the photocatalytic fiber 103 side (inside) and frame members 113, 114 which are coarse such as lattice as shown in (a) and (b) in FIG. 13 are combined can be also used. A fine net or plastic net (for example, about 60-mesh) is used as the inner net so as to hold the broken fiber 103 and the outside frame member has rigidity so as to support the fibers 103 and prevent the gas treatment unit 100 from being warped. When a metal is used for the frame member, the frame member can be formed thinly like the frame member 113. When plastics or the like is used, a frame member becomes slightly thick light the frame member 114. As a frame member, as shown in FIG. 13 (c), a fan supporting frame 115 can be also used. When the gas treatment unit 100 is provided in the passage of gas, it is unnecessary to install a fan closely. When a fan is provided and air is forcedly blown, the gas treatment capability can be improved.

When the plastic net is used on the inside, it is preferable to apply metal coating or inorganic coating on the surface of the plastic net so as not to come into contact with the photocatalyst and is not decomposed or the like. In order to return the ultraviolet rays leaked from the fibers 103 to the fibers 103, a high reflecting film of ultraviolet rays (aluminum film or the like) may be formed on a wire net. A filter member can be also formed by applying a photocatalyst on a wire net or a plastic net on which the metal coating or the like is applied and the leaked light from the fibers 103 can be used. The photocatalytic fibers 103 may be also provided in a movable part. For example, the fibers 103 can be arranged on a blade of a fan and light from a light source on the shaft side of the fan are also introduced.

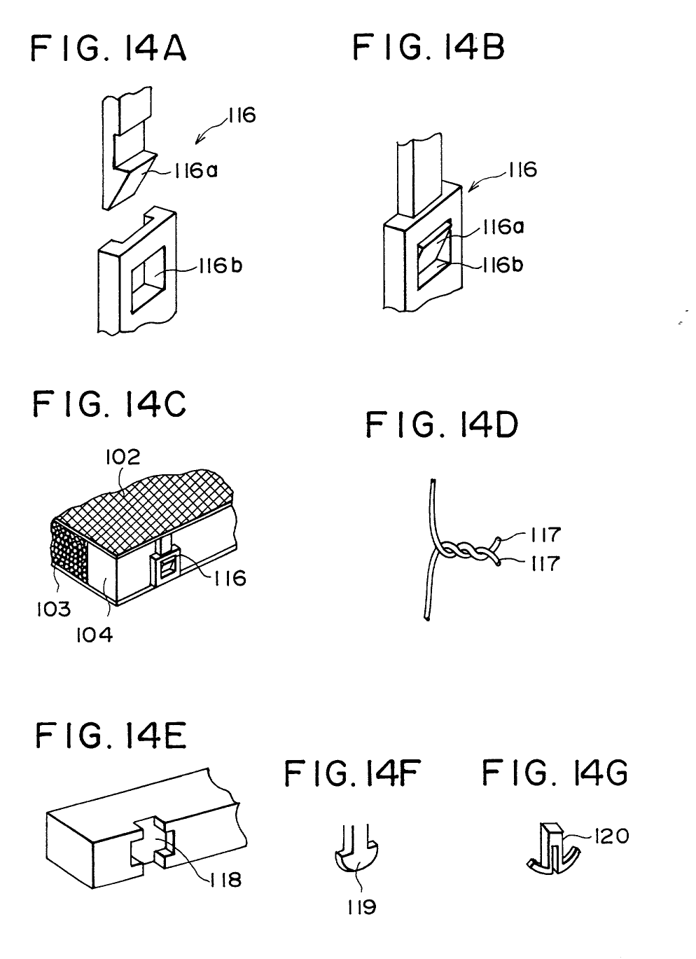

Although the metal filters 102 as a porous member are fixed to the spacers 104 by the screws 105 in the gas treatment unit 100 in FIG. 10, the invention is not limited by the arrangement. The metal filters 102 can be also fixed by using fasteners shown in FIG. 14. A fastener 116 shown in (a) and (b) in FIG. 14 is constructed by a part having a retaining protrusion 116a and the other part having a hole 116b by which the retaining protrusion 116a is retained. The fastener 116 is attached to the wire nets sandwiching the gas treatment filter or to the frame member side in FIG. 13 and is fastened as shown in FIG. 14 (c). As shown in FIG. 14 (d), wires 117 attached to the wire net or the like are twisted together to be fixed. Further, as shown in FIG. 14 (e), a retaining groove 118 can be formed in the spacer 104. On the other hand, retaining members 119 and 120 as shown in (f) and (g) in FIG. 14 are provided for the wire net side. The retaining members 119 and 120 may be inserted into the retaining groove 118 and fixed. The retaining member 119 is made of plastic having elasticity or the like. The retaining member 120 has a folded elastic piece as shown in the drawing. A method of fixing the porous member and the gas treatment filter by using an adhesive can be also used.

Although the spacer 104 in the gas treatment unit 100 in FIG. 10 is separately provided from the metal filter 102, a spacer part can be also formed integrally with a frame member in FIG. 13. The spacer can be made of, not necessarily a metal, but a material having the rigidity which is almost equal to that of plastic.

FIG. 15 shows methods of attaching the ultraviolet light 106. FIG. 15 (a) shows a method using a socket 121. FIG. 15 (b) shows a method using a holding member 122 into which the ultraviolet light 106 is inserted. FIG. 15 (c) shows a method using a protective pipe 123 made of chloroethylene or the like into which the ultraviolet light is inserted. The holding means such as the socket 121 can be integrally formed with the spacer 104 or the frame member 113.

The protective pipe 123 prevents the ultraviolet light from being broken and also serves as a safety measure. Besides, a resin can be directly applied to the tube of the ultraviolet light, the ultraviolet light can be tightly covered with a heat contractive tube, or the ultraviolet light can be loosely inserted into a tube.

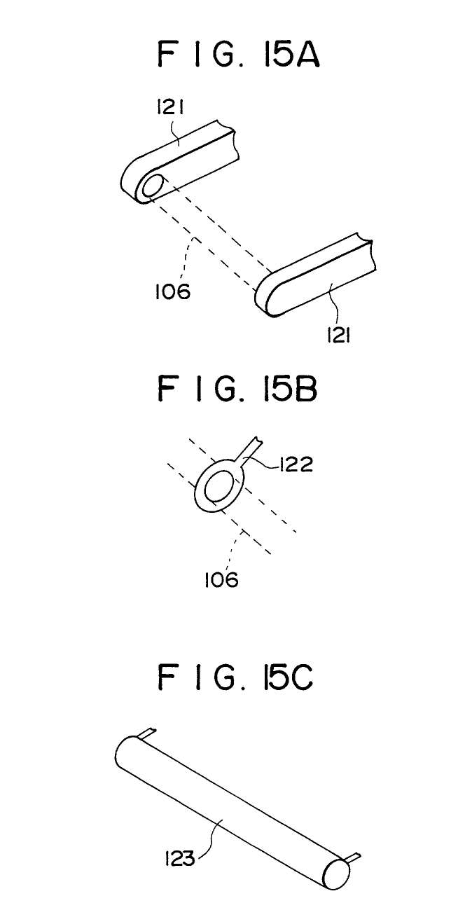

FIG. 16 shows a measure against reflection for effectively returning the ultraviolet rays from the light source to the photocatalytic fiber side. FIG. 16 (a) shows a case using a sheet 124 in which a reflecting film on which aluminum is deposited for reflecting ultraviolet rays is formed on the inner face. The sheet 124 is wound around the ultraviolet light 106 and the ends of the sheet 124 are sandwiched by the metal filters 102 and the gas treatment filter 112. The ends of the sheet 124 can be also fixed on the metal filter 102 or to the frame member. FIG. 16 (b) shows a case where an ultraviolet reflecting film 125 is applied on the face opposite to the photocatalytic fibers 103 of the ultraviolet light 106. A reflecting film reflecting ultraviolet rays may be also formed on the end face of the photocatalytic fibers on the opposite side to the ultraviolet light. Ultraviolet lights may be also provided for both ends of the photocatalytic fibers.

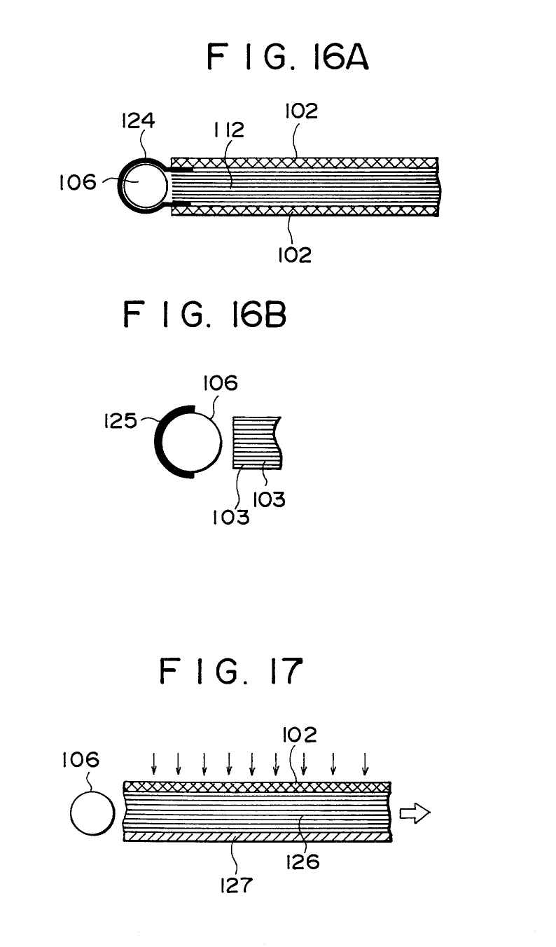

Other embodiments of the gas treatment unit are shown in FIGS. 17 to 20. A gas treatment unit shown in FIG. 17 has the structure such that one end on the ultraviolet light 106 side is bonded and fixed and the gas treatment filter 126 is sandwiched by the metal filter 102 and a plate member 127. The flow of a gas to be treated flows in from the metal filter 102 side as shown by the arrow in the diagram, flows along the fibers in a gas treatment filter 126, and flows out from the end of the gas treatment filter 126 on the side opposite to the ultraviolet light 106

FIG. 18 shows a case where a gas treatment unit 130 obtained by making the gas treatment unit of FIG. 10 curve circularly in the direction along the photocatalytic fibers 103 is used. The ultraviolet light 106 is arranged between facing both ends of the gas treatment filter 131 in the gas treatment unit 130. The gas to be treated flows in the radial direction of the tubular gas treatment unit 130.

In a gas treatment unit 132 in FIG. 19, a tubular gas treatment filter 135 is arranged between permeable members 133 and 134 of a double tube structure made of wire nets or the like along the axial directions. A ring-shaped ultraviolet light 136 is arranged on the end of the gas treatment filter 135.

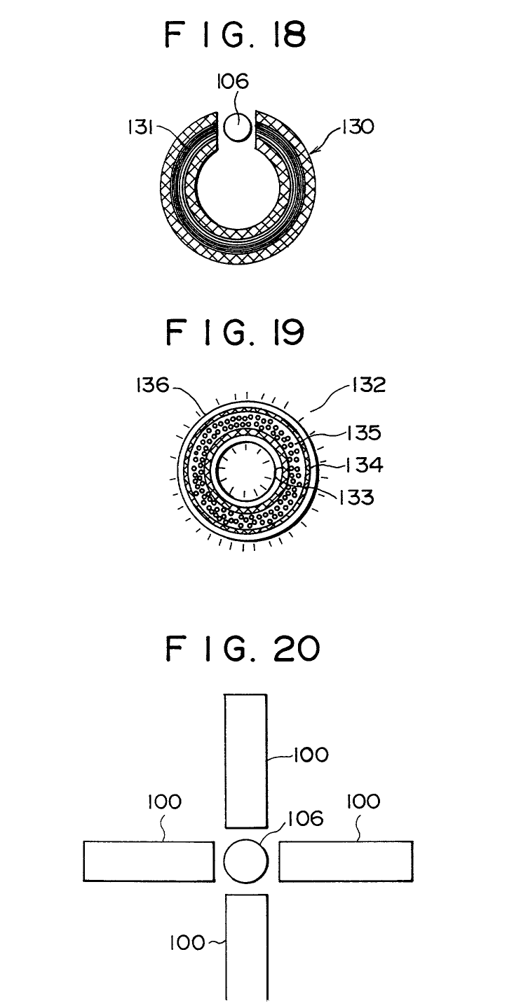

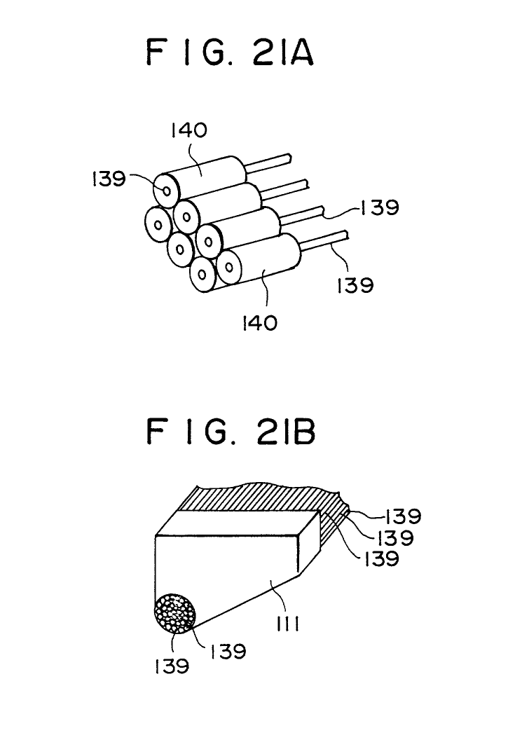

In a gas treatment unit in FIG. 20, the gas treatment units 100 of FIG. 10 are arranged around the ultraviolet light 106 with the ends of the units 100 facing the ultraviolet light 109, intending to effectively use the light of the ultraviolet light 106.

FIG. 21 shows another embodiment of the gas treatment filter. FIG. 21 (a) shows a gas treatment filter using fiber-shaped light guiding members 139 on which photocatalysts are carried on the surface. As shown in the diagram, the ends of the light guiding members 139 are covered with a covering material 140 made of resin, glass, and the like. By bundling and fixing the ends of the light guiding members 139 covered with the covering material 140 by using a binder such as an adhesive, a gas treatment filter is formed. For forming the covering material 140, for example, it is sufficient to dip the ends of the conductive member 139 in a resin. In this case, in order to immerse a number of light guiding members 139 in the resin in a state where they are apart from each other, a porous plate having a number of holes through which the light guiding members 139 can pass may be used or the light guiding members 139 can be charged and are separated by static electricity.

In a gas treatment filer of FIG. 21 (b), the fiber-shaped light guiding members 139 which are apart from each other at proper intervals are bound and fixed at their ends by the binder 111. In the manufacture, for example, it is sufficient to bundle and fix the tips of the light guiding members 139 inserted through the porous plate by the binder 111. The photocatalytic fibers 103 having protrusions may be also used for the gas treatment filter shown in FIG. 21. The gas treatment unit can be also constructed by housing the gas treatment filter in a box-shaped container or the like having permeability.

What is claimed is:

1. A filter material in which protrusions are formed on the surface of a filter base material by combining said filter base material in which at least a part is covered by a photocatalyst or a material containing a photocatalyst and particles for forming protrusions.

2. The filter material according to claim 1, wherein said filter base material is a glass fiber.

3. The filter material according to claim 1 or 2, wherein said photocatalyst or said material containing photocatalyst is titanium dioxide or a material containing titanium dioxide.

4. A method of manufacturing a filter material, comprising:
a first step of covering a filter base material and particles for forming protrusions with a photocatalyst or a material containing a photocatalyst; and
a second step of forming protrusions on the surface of said filter base material by combining said filter base material and said particles for forming protrusions.

5. The method according to claim 4, wherein said first step and said second step are simultaneously performed.

6. A method of manufacturing a filter material, comprising:
a first step of covering a fiber base material and particles for forming protrusions with a photocatalyst precursor;
a second step of performing an operation for transforming said photocatalyst precursor into a photocatalyst; and
a third step of forming protrusions on the surface of said filter base material by combining said filter base material and said particles for forming protrusions.

7. The method according to claim 6, wherein said first to third steps are simultaneously performed.

8. A gas treatment apparatus comprising:
a gas treatment filter made of a filter material in which a photocatalyst having a refractive index higher than a refractive index of a filter base material is carried on the surface of the filter base material;
means for introducing ultraviolet rays from an end face of said filter into said filter base material; and
means for allowing the ultraviolet rays introduced into said filter base material to leak from said photocatalyst and irradiating the ultraviolet rays to gas in atmosphere to be treated in which said gas treatment filter is installed.

9. A gas treatment apparatus comprising:
a photocatalytic fiber in which a photocatalyst having a refractive index higher than that of a fiber-shaped light guiding member is carried on the surface of the light guiding member having protrusions formed on the surface;
a porous member for properly binding said photocatalytic fibers and constructing a gas treatment unit;
means for introducing ultraviolet rays from an end face of said bundled photocatalytic fibers into said light guiding member; and
means for allowing the ultraviolet rays introduced into said light guiding member to leak from said photocatalyst and irradiating the ultraviolet rays to gas in atmosphere to be treated in which said gas treatment filter is installed.

10. The apparatus according to claim 8, wherein said filter material is glass.

11. The apparatus according to claim 9, wherein said light guiding member is glass.

12. The apparatus according to claim 9 or 11, wherein a spacer is interposed between said porous members.

13. A gas treatment filter having:
a photocatalytic fiber in which a photocatalyst having a refractive index higher than that of a fiber-shaped light guiding member is carried on the surface of said light guiding member; and
means for arranging the longitudinal direction of a number of said photocatalytic fibers and constructing a gas treatment unit,
wherein at least one end faces of said photocatalytic fibers are fixed by a binder and each of end faces of said light guiding members is polished.

14. A gas treatment apparatus comprising:
photocatalytic fibers in which protrusions are formed on the surface of a filter base material by combining said filter base material and particles for forming protrusion having at least a part covered by a photocatalyst or a material containing the photocatalyst;
means for arranging the longitudinal direction of a number of said photocatalytic fibers and constructing a gas treatment unit;
means for introducing ultraviolet rays from end faces of said bundled photocatalytic fibers into said filter base material; and
means for allowing the ultraviolet rays introduced into said filter base material to be leaked from said photocatalyst and irradiating the ultraviolet rays to gas in atmosphere to be treated in which said gas treatment unit is installed.
